(19) United States
(12) Patent Application Publication
(10) Pub. No.: US 2004/0110486 A1
(43) Pub. Date: Jun. 10, 2004

(54) Method For Incentivising Wireless Device Use

(75) Inventor: Scott Andrew Sobel, Carlsbad, CA (US)

Correspondence Address: KRISTEN E. CAVERLY, HENDERSON & CALVERLY LLP, P.O. BOX 9144, RANCHO SANTA FE, CA, 92067, US

(73) Assignee: TELESPATIAL, INC., McLean, VA (US)

(21) Appl. No.: 10/604,584

(22) Filed: Jul. 31, 2003

Related U.S. Application Data
(60) Provisional application No. 60/400,538, filed on Aug. 1, 2002.

(51) Int. Cl. H04M 11/00

(52) U.S. Cl. 455/405; 455/406

(57) ABSTRACT

The present invention provides a method for incentivising consumers to purchase or renew contracts for wireless communication services and to permit vendors to transmit text, audio and graphic messages to them. The consumer is incentivised by earning reward points for subscribing for wireless service, timely payment of invoices for wireless service and/or other criteria. The reward points can be used by the wireless subscriber as currency to purchase and/or for discounts on goods and services offered by participating vendors and retailers.

### CROSS REFERENCE TO RELATED APPLICATIONS

Applicant claims priority to Aug. 1, 2002 based on U.S. provisional application 60/400538, filed as of that date.

### BACKGROUND OF INVENTION

Personal wireless communication devices, such as pagers, cellular phones, and handhelds, are in widespread use. There are many examples of wireless communication devices in use today. For example, U.S. Pat. No. 6,385,463 describes a wireless communication device with detachable flip keyboard. U.S. Pat. No. 6,415,138 describes a wireless communication device and a method of manufacturing a wireless communication device.

Wireless communication devices can be used anywhere that the wireless network reaches to send and receive text, audio and graphic messages, access the internet, make telephone calls, and send and receive e-mail messages.

It is known that text, audio and graphic messages may be forwarded from one source to one or more wireless communication devices. A method and system for a wireless digital message service is described in U.S. Pat. No. 6,349,135. A system and method for forwarding messages to a subscriber device is described in U.S. Pat. No. 6,405,035. Methods, such as described in U.S. Pat. No. 6,381,465, are known for sending unsolicited advertisements to wireless devices attached to a solicited text, or SMS, message. It also is known that wireless communication devices may be used to receive or send messages upon arrival at a predetermined location, such as described in U.S. Pat. No. 6,360,101.

It is known that persons wishing to use a cellular phone or other wireless communication device may purchase, rent or lease a wireless device, and purchase or subscribe for service with a wireless service provider, also called a wireless carrier. It also is known that there is a lot of competition amongst carriers to get new accounts and to maintain the accounts that they have. Some carriers compete in this area by partnering with wireless device manufacturers to offer special pricing on the device if purchased in conjunction with service from the partner carrier. To incentivize wireless consumers to deal with a particular carrier, wireless carriers also are known to provide package plans, which include service for multiple users at a discount and/or provide service to multiple wireless devices at a discount. It is desirable to provide an additional method whereby wireless carriers can incentivize wireless subscribers to subscribe to their services and to renew those subscriptions.

Reward or incentive programs can be found in the airline industry, where it is common for passengers to be awarded “frequent flyer” miles. These “miles” or points can be used towards future travel on a particular carrier or, in some cases, may be traded for cash, goods or services provided by the carrier or a partner business, such as for magazine subscriptions and hotel accommodations.

Reward or incentive programs also can be found in the credit card industry, where it is common for credit card users to be awarded “frequent flyer miles” to be used on a partner airline, cash awards, and/or points, which can be traded for goods or services provided by the credit card issuer or a partner business.

Incentive programs also are used in the gaming industry. For example, it is known that gaming establishments may provide frequent flyer miles, hotel accommodations and discounts, and prepaid telephone time in exchange for time spent in the casino at gaming tables. These rewards are intended to encourage use of the casino's facilities and/or games. For example, U.S. Pat. No. 6,379,247 describes a method and system for awarding frequent flyer miles for casino table games; U.S. Pat. No. 6,377,669, describes a method and apparatus for awarding and redeeming prepaid telephone time as part of a slot machine incentive program.

The incentive programs found in the industry prior to this invention do not provide an incentive to consumers of wireless services to use such services while providing a virtually real-time platform for advertising goods and services directly to the wireless subscriber who then is given points which may be redeemed for discounts on such advertised goods or services.

### SUMMARY OF INVENTION

The present invention overcomes the limitations of the prior art noted above by providing a method of incentivising consumers of wireless services to use a particular wireless carrier and to comply with the terms of his/her wireless carrier contract while allowing vendors of goods and services to transmit wireless messages directly to wireless subscribers at any time of the day or night.

The invention provides a method whereby: wireless subscribers are informed of a wireless carrier's reward program prior to or after subscribing for wireless services from such carrier; the wireless subscriber is enrolled in the wireless carrier's reward program; the wireless carrier is partnered with vendors desiring to advertise to the carrier's subscribers; the wireless subscriber is sent messages from vendors partnered with the carrier based on the terms of the reward program; the subscriber is awarded points based on their monthly airtime usage and by keeping their account in good standing or other criteria such as number of messages received on a monthly basis; and the subscriber is provided a means for using his/her reward points to purchase goods or services or to obtain discounts or good and services from retailers and/or vendors partnered with the carrier or third party facilitators.

Advantages of the invention may include one or more of the following: (1) providing a new method of incentivising consumers to purchase wireless services; (2) providing a method for vendors of goods and services to use a wireless carrier's network and customer base to advertise and promote those goods and services at low cost to the vendor; (3) providing a method for wireless subscribers to learn of new products, discounts and special offers being provided by vendors of goods and services; (4) providing a method for wireless subscribers to earn discounts or free goods and services from such vendors; and (5) reducing subscriber churn and increasing ARPU (average revenue per user) are significant advantages for the wireless carriers. Other advantages will be apparent from the description that follows.

### BRIEF DESCRIPTION OF DRAWINGS

Preferred embodiments of the invention are described below with reference to the accompanying drawing, which is briefly described below.

FIG. 1 is a block diagram illustrating an embodiment of the invention.

### DETAILED DESCRIPTION

The following definitions are given as a guide to understanding the invention, but are not intended to be limiting of the invention.

The term “debit card” is intended to mean (a) a card with value encoded on the magnetic stripe, which is re-encoded with a lower value at each use; or (b) a magnetic stripe card used with a PIN number to authorize electronic debit of funds from an account.

The term “retailer” is intended to include any company, entity or person who markets, advertises, sells, rents, leases and/or offers to sell, rent or lease goods and/or services to wireless subscribers, the public, or any segment or portion thereof, whether or not located in a physical location which can be accessed by the public and/or doing business in person, electronically, over the internet, by telephone, by mail or by any other means for communication.

The term “vendor” is intended to include any company, entity or person who uses a wireless carrier's network or wireless carrier's relationship with a wireless subscriber, including the wireless carrier itself, to send a wireless subscriber electronic data which is intended for display or presentation using the wireless subscriber's wireless device(s).

The term “wireless carrier” is intended to mean any company, entity or person that provides communication services, internet service, software and/or hardware related to a wireless device.

The term “wireless device” is intended to include any equipment, machine, phone, computer or other goods which function to receive and/or send data without the necessary use of wires or cabling, whether or not wires or cabling are utilized for the convenience of the wireless subscriber. Examples of wireless devices are cellular telephones, pagers, handheld and laptop computers, so called end-to-end wireless e-mail solutions, such as the Blackberry™, PDAs, etc.

The term “wireless subscriber” is intended to mean any company, entity, or person who owns, leases, possesses, contracts for or subscribes to services for, or uses a wireless device.

In the invention, the wireless subscriber contractually agrees to receive text and/or graphic messages via a particular wireless device or group of devices, such as a cellular phone or handheld wireless device, from vendors and, in return, is awarded points for subscription for wireless service, use of his/her wireless network, and/or timely payment of invoices for his/her wireless use. These text, audio and graphic messages may advise the wireless subscriber, for example, of special pricing, new products, promotions, opportunities to earn additional rewards, etc. The wireless carrier, such as Verizon® or AT&T®, and/or third party facilitator are paid a fee or other incentive by the vendor to allow the vendor to transmit messages over the carrier's wireless network.

The contract between the wireless carrier and the wireless subscriber, which allows the wireless carrier to transmit text, audio, and graphic messages to the wireless subscriber, may be facilitated by a retailer, such as Sam's Club® or Best Buy®, which provides a location at which wireless subscribers can purchase wireless devices and/or contract for wireless services with a carrier. The retailer may provide this service via its own employees or may outsource this service to another entity or person(s).

In the invention, the wireless carrier directly may locate and contract with vendors willing to use the carrier's network to send messages to wireless subscribers. In the alternative, a third party facilitator or broker may be used to locate vendors willing to advertise using a particular carrier's network, to locate carriers willing to transmit such vendors messages, and to manage the business relationship between the vendors and carrier. This facilitator may be a retailer, vendor, or third party.

The text, audio and/or graphic messages may be sent via any available technology. For example, short text messages may be sent using the SMS application, also known as short message service. The method and apparatus used for transmission of the message from the vendor to the carrier and from the carrier to the subscriber's wireless device is not limiting to the invention.

An example of how the invention can operate is as follows. A wireless subscriber enters a retailer's physical store location. Either through visual or audio advertisement, the wireless subscriber is informed that a particular wireless carrier offers a reward or incentive program for subscribing to or using the services of that carrier. For example, a wireless subscriber may approach a display of wireless devices and be informed by a sales clerk that a particular wireless carrier is offering an incentive program. The sales clerk may be an employee of the retailer or an independent contractor. The sales clerk may inform the wireless subscriber of the incentive program in conjunction with providing information to the wireless subscriber about wireless devices offered for sale, rent or lease by the retailer. In this example, the sales clerk, personally or through the use of visual or audio material, explains to the customer that when he/she signs up with a particular carrier and selects service which includes the incentive program, the wireless subscriber will be credited with reward points, which relate to a percentage of every dollar the wireless subscriber pays the carrier.

Wireless subscribers with an existing relationship with carriers may be informed of the wireless reward program and offered the opportunity to opt into the reward program by direct communication from the carrier or through contact from a third party, including a retailer, facilitator or vendor. Invitations to participate in the wireless rewards program may be sent to wireless subscribers via the mail, e-mail, and/or on designated web sites. Other methods to invite existing subscribers to participate also may be made available.

Terms of the rewards program and how and when the rewards points can be used by the wireless subscriber are communicated to the wireless subscriber by the carrier, the retailer, or any third party acting on behalf thereof. The terms of the rewards program and how and when the rewards points can by used by the wireless subscriber are not limitations of the invention.

The sales clerk further explains the specific details of the program concerning how to opt out, penalties for late payment of invoices, and how the subscriber will be notified of his/her point balance. Once the subscriber opts into the reward program, the carrier is notified by the retailer or associated third party that the subscriber has opted in, the carrier or an associated party then establishes an account to track award points earned by the wireless subscriber and to inform the wireless subscriber of his/her point balance.

In exchange for receiving reward points, the wireless subscriber agrees to receive a certain number of electronic messages, which may include text, audio, graphics, links to internet websites, etc., in a specified time period, such as two messages per day, week, or month, or when the wireless subscriber arrives or leaves a particular location. Text messages currently are sent to wireless devices using SMS, or Short Message Service, but that is not a limitation of the invention.

Messages sent to the wireless subscriber can focus on special offers from vendors of the participating retailers. Retailers, vendors and/or third parties may contract with the carrier to send messages to that carrier's wireless subscribers. The content and form of the messages sent to wireless subscribers are not limitations of the invention. The technical means or apparatus for transmitting the messages from the vendor to the wireless subscriber, other than that the messages are display or presented through the use of one or more wireless devices, are not limitations of the invention.

In the invention, a wireless subscriber may earn reward points for any action or agreement by the wireless subscriber. For example, a wireless subscriber may receive reward points for signing up for a particular level of service from the carrier, paying his/her bill on time, renewing wireless service, purchasing the services of a business partner of the carrier, purchasing goods or services of an advertiser using the carrier's network to advertise to the wireless subscriber, and/or agreeing to receive a particular number of text, audio or graphic messages from the carrier's business partners or vendors.

Subscribers are notified of their wireless reward point balances via their wireless carrier monthly billing statement or other methods, such as special mailers, via e-mail, or via a designated web site. Third party facilitators may also handle the task of updating subscribers regarding their point balances, participating retailers, and point redemption procedures.

The subscriber may be permitted to opt out of the program at any time or after some notice period. However, when a subscriber opts out, he/she will stop accumulating points and may lose points already accumulated, depending upon the terms of the particular wireless carrier's reward point program. The wireless carrier may terminate subscriber participation in the reward program for reasons such as late payment of invoices or deletion of incoming vendor messages without viewing. The carrier can reserve the right to revoke accumulated points in the program for reasons the carrier deems appropriate.

The reward points earned by the wireless subscriber may be utilized to purchase goods or services at participating retailers. In an embodiment of the invention, reward points are converted into currency that may be used to purchase goods and services at participating retailers. Discounts on services or goods of participating retailers may also be realized at the time of sale. The retailer reward points from the wireless subscriber's account, which may be accessed via the wireless subscriber's wireless device, through telephone or other communications between the retailer and the carrier and/or by use of a magnetic stripe transaction card, such as a debit card, which can be read and re-encoded using a magnetic strip reader/writer or electronic data capture (EDC) magstripe card swipe terminal. Any other means of notification from the vendor to the carrier that award points have been used by the wireless subscriber also are suitable for the invention. Other forms of point redemption conversion into acceptable payment at participating retailers may also be deemed appropriate.

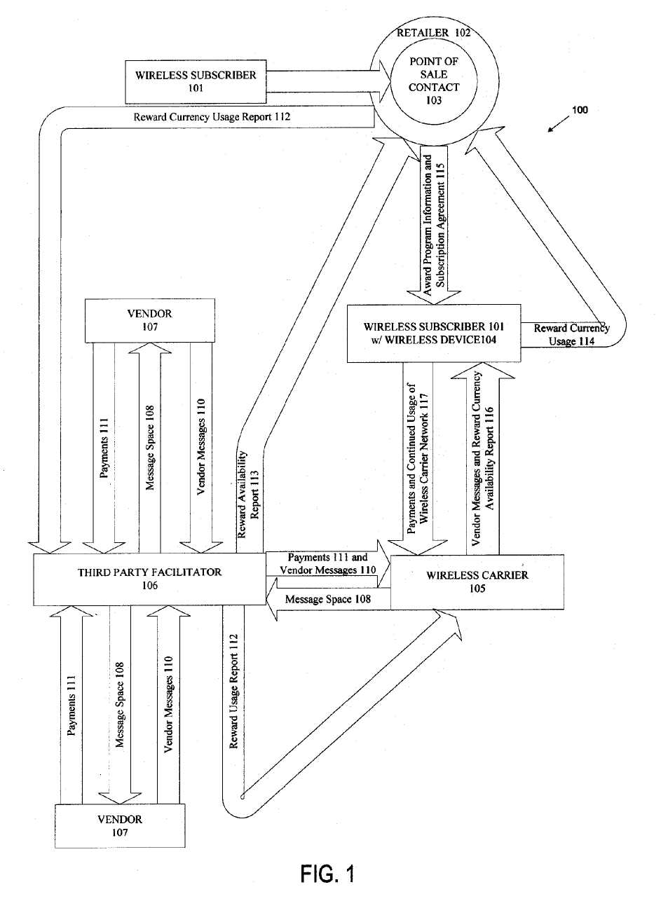

FIG. 1 illustrates an embodiment of the invention. The embodiment 100 includes the following participants: (1) wireless subscriber 101, new and/or existing; (2) third party facilitator 106, e.g., Telespatial, Inc.; (3) retailer 102; (4) wireless carrier 105; (5) point of sale contact to assist the subscriber in sign up and message delivery 103; and (6) vendors of the participating retailers 107.

The participants in the embodiment 100 work together as follows. First, the subscriber 101 visits, physically or electronically, a retailer 102 for the purpose of purchasing a wireless device 104. The point of sale contact 103, which can be a retailer 102 or other facilitator, informs the subscriber of a particular carrier's reward program 115. The subscriber then agrees to participate in the wireless reward program in conjunction with the purchase, rent or lease of a wireless device or subscription for services from wireless carrier 105.

In the embodiment 100, the third party facilitator 106 purchases text message space 108 from a wireless carrier 105. The third party facilitator 106 identifies vendors 107 desiring to deliver text messages to wireless subscribers 101 and resells such vendors 107 text message space 108 from the wireless carrier 105 proving service to the target subscribers 101. After resale of message space 108 111, the third party facilitator 106 will work with the vendor 107 on the content and formation of messages 110. Then the third party facilitator 106 will work with the wireless carrier 105 to complete delivery of the messages 110 to the wireless subscribers” wireless device 104 via the carrier's wireless network.

In the embodiment 100, the third party facilitator also tracks wireless reward points credited to and used by subscribers 112 and enables point/credit transactions at points of sale by reporting reward currency availability 113 to the retailer 102.

In another embodiment, the subscriber agrees to receive vendor messages without receipt of wireless reward points from a carrier. In this embodiment a facilitator, either a sales clerk employed by the retailer or a third party under contract to sell wireless devices for the retailer, would sign up the subscriber to receive vendor messages. In this embodiment, the subscriber would not earn points from the carrier, but would agree to receive messages from vendors for the benefit of receiving messages informing him/her of special offers from vendors at selected retailers. In this embodiment, the facilitator would purchase text message space from a wireless carrier and resell that space to vendors. The facilitator then would work with the carrier to ensure delivery of the messages from the vendor to the wireless subscriber. The facilitator tracks the delivery of the messages and handles reporting to the vendor community.

Although preferred embodiments of the invention have been described in detail, it will be understood by those skilled in the art that various modifications can be made therein without departing from the spirit and scope of the invention as set forth in the appended claims.

I claim:

1. A method of incentivising wireless device use, comprising the steps of:
(a) informing a wireless subscriber of the terms of a reward program offered by a wireless carrier;
(b) obtaining an agreement between said wireless subscriber and said wireless carrier whereby said wireless subscriber agrees to participate in said reward program;
(c) determining whether said wireless subscriber qualifies for one or more rewards based on said wireless subscriber's performance of said agreement to participate in said reward program;
(d) calculating said rewards if said wireless subscriber qualifies for one or more rewards; and
(e) recording said rewards in an account correlated with said wireless subscriber, if said wireless subscriber qualifies for one or more rewards, wherefrom said rewards are redeemable by said wireless subscriber according to said agreement to participate in said reward program.

2. A method as set forth in claim 1, wherein the step of informing a wireless subscriber of the terms of a reward program offered by a wireless carrier is performed by a retailer.

3. A method as set forth in claim 1, wherein the step of informing a wireless subscriber of the terms of a reward program offered by a wireless carrier is performed by a retailer via a face-to-face communication with said wireless subscriber.

4. A method as set forth in claim 1, further comprising the step of advising said wireless subscriber of the rewards for which said wireless subscriber qualified.

5. A method as set forth in claim 1, wherein said rewards have a monetary value.

6. A method as set forth in claim 1, wherein
(a) said rewards have a monetary value; and
(b) the step of recording said rewards includes the recording of said rewards on a debit card;
and further comprising the step of providing said debit card to said wireless subscriber.

7. A method as set forth in claim 1, wherein said reward program provides that said wireless subscriber qualifies for rewards by paying for the use of wireless services.

8. A method as set forth in claim 1, wherein said reward program provides that said wireless subscriber qualifies for rewards by subscribing for the use of wireless services.

9. A method as set forth in claim 1, wherein said reward program provides that said wireless subscriber qualifies for rewards by receiving electronic data intended for display or presentation from a vendor via a wireless device.

10. A method as set forth in claim 1, wherein said reward program provides that said wireless subscriber qualifies for rewards by receiving electronic data intended for display or presentation from a vendor via a wireless device and wherein said wireless device is a device selected from the group consisting of cellular phones, personal data assistants, and end-to-end wireless e-mail solutions.

11. A method as set forth in claim 1, wherein said reward program provides that said wireless subscriber qualifies for rewards by receiving electronic data intended for display or presentation from a vendor via a wireless device and further comprising the step of transmitting electronic data to said wireless subscriber via a wireless device, wherein said step of transmitting occurs in relation to a schedule.

12. A method as set forth in claim 1, wherein said reward program provides that said wireless subscriber qualifies for rewards by receiving electronic data intended for display or presentation from a vendor via a wireless device and further comprising the step of transmitting electronic data to said wireless subscriber via a wireless device, wherein said step of transmitting occurs in relation to said wireless device reaching a predetermined geographic position.

13. A method of rewarding receipt of electronic data by a wireless device subscriber, comprising the steps of:
(a) obtaining an agreement from a wireless subscriber to receive electronic data via a wireless device;
(b) transmitting electronic data to said wireless subscriber via said wireless device; and
(c) awarding points to said wireless subscriber based on said wireless subscriber's receipt of said electronic data.

14. A method as set forth in claim 13, wherein said points have a monetary value.

15. A method as set forth in claim 13, wherein
(a) said points have a monetary value; and
(b) the step of recording said rewards includes the recording of said rewards on a debit card;
and further consisting essentially of the step of providing said debit card to said wireless subscriber.

16. A method as set forth in claim 13, wherein the step of transmitting electronic data from said wireless carrier to said wireless subscriber via said wireless device occurs in relation to a schedule.

17. A method as set forth in claim 13, wherein the step of transmitting electronic data from said wireless carrier to said wireless subscriber via said wireless device occurs in relation to said wireless device reaching a predetermined geographic position.

18. A method of rewarding receipt of electronic data by a wireless device subscriber, comprising the steps of:
(a) obtaining an agreement from a wireless subscriber to receive electronic data from a vendor via a wireless device;
(b) obtaining message space by said vendor from a wireless carrier;
(c) transmitting electronic data from said vendor to said wireless carrier;
(d) transmitting electronic data from said wireless carrier to said wireless subscriber via said wireless device; and
(e) awarding points to said wireless subscriber based on said wireless subscriber's receipt of said electronic data.

19. A method as set forth in claim 18, wherein said points have a monetary value.

20. A method as set forth in claim 18, wherein the step of transmitting electronic data from said wireless carrier to said wireless subscriber via said wireless device occurs in relation to a schedule.

21. A method as set forth in claim 18, wherein the step of transmitting electronic data from said wireless carrier to said wireless subscriber via said wireless device occurs in relation to said wireless device reaching a predetermined geographic position.

22. A method of rewarding receipt of electronic data by a wireless device subscriber, consisting essentially of the steps of:
(a) obtaining an agreement from a wireless subscriber to receive electronic data from a vendor via a wireless device;
(b) obtaining message space by said vendor from a wireless carrier;
(c) transmitting electronic data from said vendor to said wireless carrier;
(d) transmitting electronic data from said wireless carrier to said wireless subscriber via said wireless device;
(e) awarding points to said wireless subscriber based on said wireless subscriber's receipt of said electronic data;
(f) recording said points in an account correlated with said wireless subscriber; and
(g) advising said wireless subscriber of said points awarded to said wireless subscriber.

23. A method as set forth in claim 22, wherein said points have a monetary value.

24. A method as set forth in claim 22, wherein
(a) said points have a monetary value; and
(b) the step of recording said rewards includes the recording of said rewards on a debit card;
and further consisting essentially of the step of providing said debit card to said wireless subscriber.

25. A method of rewarding receipt of electronic data by a wireless device subscriber, comprising the steps of:
(a) obtaining an agreement from a wireless subscriber to receive electronic data from a vendor via a wireless device;
(b) obtaining message space by said vendor from a wireless carrier;
(c) transmitting electronic data from said vendor to said wireless carrier;
(d) transmitting electronic data from said wireless carrier to said wireless subscriber via said wireless device;
(e) awarding points to said wireless subscriber based on said wireless subscriber's receipt of said electronic data;
(f) recording said points in an account correlated with said wireless subscriber; and
(g) advising said wireless subscriber of said points awarded to said wireless subscriber.

26. A method as set forth in claim 25, wherein
(a) said step of obtaining message space by said vendor from a wireless carrier comprises a third party facilitator obtaining message space from said wireless carrier and said third party facilitator in turn transferring said message space to said vendor; and
(b) said step of transmitting electronic data from said vendor to said wireless carrier comprises said vendor transmitting said electronic data to said third party facilitator who in turn transmits said electronic data to said wireless carrier.

27. A method as set forth in claim 25, wherein said wireless device is a device selected from the group consisting of cellular phones, personal data assistants, and end-to-end wireless e-mail solutions.

28. A method as set forth in claim 25, wherein said points have a monetary value.

29. A method as set forth in claim 25, wherein
(a) said points have a monetary value; and
(b) the step of recording said rewards includes the recording of said rewards on a debit card;
and further comprising the step of providing said debit card to said wireless subscriber.

30. A method as set forth in claim 25, wherein the step of transmitting electronic data from said wireless carrier to said wireless subscriber via said wireless device occurs in relation to a schedule.

31. A method as set forth in claim 25, wherein the step of transmitting electronic data from said wireless carrier to said wireless subscriber via said wireless device occurs in relation to said wireless device reaching a predetermined geographic position.

32. A method as set forth in claim 25, wherein
(a) the step of transmitting electronic data from said wireless carrier to said wireless subscriber via said wireless device occurs in relation to a schedule; and
(b) said wireless device is a device selected from the group consisting of cellular phones, personal data assistants, and end-to-end wireless e-mail solutions.

33. A method as set forth in claim 25, wherein
(a) the step of transmitting electronic data from said wireless carrier to said wireless subscriber via said wireless device occurs in relation to said wireless device reaching a predetermined geographic position; and
(b) said wireless device is a device selected from the group consisting of cellular phones, personal data assistants, and end-to-end wireless e-mail solutions.
